(19) United States
(12) Patent Application Publication
(10) Pub. No.: US 2026/0060275 A1
(43) Pub. Date: Mar. 5, 2026

(54) DISCHARGE DEVICE WITH LOCKING TRIGGER STRUCTURE FOR COLD BEVERAGE MAKER AND COLD BEVERAGE MAKER

(71) Applicant: Guangdong Welly Electrical Appliances Co., Ltd., Zhongshan (CN)

(72) Inventors: Xiangan Wu, Zhongshan (CN); Linjun Mai, Zhongshan (CN); Yangyang Ma, Zhongshan (CN); Wenzhan Hu, Zhongshan (CN)

(21) Appl. No.: 19/078,343

(22) Filed: Mar. 13, 2025

(30) Foreign Application Priority Data
Aug. 29, 2024 (CN) 202422118912.0

(51) Int. Cl. A23G 9/28

(52) U.S. Cl. CPC A23G 9/281

(57) ABSTRACT

The present disclosure provides a discharge device with a locking trigger structure for a cold beverage maker and a cold beverage maker. The discharge device with a locking trigger structure for a cold beverage maker includes a housing and a discharge disc, where the housing is provided with a first discharge port; the discharge disc is provided with a second discharge port; the discharge disc is mounted on the housing through a clamping structure; the housing is provided with a microswitch on a top of the first discharge port; and the clamping structure is configured to detachably lock the discharge disc and the housing. The present disclosure prevents accidental leakage or damage due to a fact that the discharge disc is not locked, and greatly improves the safety of the operation.

### CROSS REFERENCE TO RELATED APPLICATIONS

The present application claims the benefit of Chinese Patent Application No. 2024221189120 filed on Aug. 29, 2024, the contents of which are incorporated herein by reference in their entirety.

### TECHNICAL FIELD

The present disclosure relates to the technical field of cold beverage makers, and in particular to, a discharge device with a locking trigger structure for a cold beverage maker and a cold beverage maker.

### BACKGROUND

The cold beverage makers generally include ice cream makers or smoothie makers, and are configured to make ice cream or smoothie. The conventional cold beverage makers are often designed based on the discharge efficiency and mouthfeel, without considering the safety comprehensively. For many types of cold beverage makers, there lacks effective technical means to detect a locked state of the discharge disc. When the discharge disc is replaced, the locked state of the discharge disc is often determined only through subjective judgment or experience of the worker. This is inefficient and sometimes causes an error.

Once the locked state of the discharge disc is not determined, but the discharge operation is started, the ice cream or smoothie may be leaked accidentally. The leaked ice cream or smoothie not only wastes raw materials, but also pollutes an internal structure of the cold beverage maker to affect quality of the subsequent product.

### SUMMARY

In view of the above defect, the present disclosure provides a discharge device with a locking trigger structure for a cold beverage maker and a cold beverage maker. After the discharge disc is mounted, the microswitch can detect whether the discharge disc is correctly and firmly locked on the housing in real time. When identifying the locked state of the discharge disc, the microswitch turns the circuit on to ensure normal discharge operation of the cold beverage maker. This prevents accidental leakage or damage due to a fact that the discharge disc is not locked, greatly improves the safety of the operation, and solves the problems of low efficiency and high error rate of the conventional method that determines the locked state of the discharge disc through experience of the worker.

In order to achieve the above objective, the present disclosure adopts the following technical solutions:

The present disclosure provides a discharge device with a locking trigger structure for a cold beverage maker, including a housing and a discharge disc, where the housing is provided with a first discharge port; the discharge disc is provided with a second discharge port; the discharge disc is mounted on the housing through a clamping structure; the housing is provided with a microswitch on a top of the first discharge port; the clamping structure is configured to detachably lock the discharge disc and the housing; the discharge disc is configured to seal the first discharge port; and the microswitch is configured to identify whether the discharge disc is locked and turn a circuit on or off; and
the first discharge port communicates with the second discharge port; and the second discharge port is configured to discharge ice cream or smoothie.

The housing is provided with an annular groove at the first discharge port; the annular groove is provided around the first discharge port; a side of the discharge disc close to the housing is provided with a circular ring; and the circular ring is movably stretched into the annular groove; and
the clamping structure includes a first clamping member and a second clamping member; a plurality of first clamping members are provided around a sidewall of the annular groove; a plurality of second clamping members are provided around a sidewall of the circular ring; and the first clamping member and the second clamping member are in one-to-one correspondence, and are clamped with each other.

The microswitch includes an elastic piece, a first locating member, a second locating member, and a sensor; the first locating member is mounted on a sidewall of the annular groove; the second locating member is mounted on the circular ring; the first locating member and the second locating member are in one-to-one correspondence, and are clamped with each other; the annular groove is provided with a locating hole at the first locating member; the sensor is mounted on a top of the locating hole of the housing; the elastic piece includes a mounting end provided on the sensor, and a movable end movably stretched into the locating hole; and the second locating member movably passes through the locating hole, and upwardly abuts against the elastic piece.

The elastic piece includes a tilt portion and an abutment portion; the tilt portion is obliquely connected to the sensor and the abutment portion; and the abutment portion movably penetrates into the locating hole.

The first locating member includes a guiding portion and a locating portion; the guiding portion and the locating portion are provided around the locating hole; the locating portion includes one end connected to an inner wall of the annular groove, and the other end perpendicularly connected to the guiding portion; and a length direction of the locating portion is the same as an axial direction of the first discharge port.

The first clamping member includes a first vertical portion and a first horizontal portion that are perpendicular to each other; an end of the first vertical portion away from the first horizontal portion is connected to an inner wall of the annular groove; and the first horizontal portion is flush with an outer surface of the housing;
the second clamping member includes a second vertical portion and a second horizontal portion that are perpendicular to each other; an end of the second vertical portion away from the second horizontal portion is connected to an inner wall of the discharge disc; and the first horizontal portion is flush with an end of the circular ring; and
both a length direction of the first vertical portion and a length direction of the second vertical portion are the same as an axial direction of the first discharge port.

A side of the second horizontal portion close to the first horizontal portion is provided with a second tilt sub-portion and a depression sub-portion; and two ends of the depression sub-portion are respectively connected to two second tilt sub-portions;
a side of the first horizontal portion close to the second horizontal portion is provided with a first tilt sub-portion and a protrusion sub-portion; and two ends of the protrusion sub-portion are respectively connected to two first tilt sub-portions; and
the depression sub-portion is clamped with the protrusion sub-portion; and the first tilt sub-portion abuts against the second tilt sub-portion.

The second horizontal portion of the second clamping member is close to the second vertical portion of the adjacent second clamping member; and
the first horizontal portion of the first clamping member is close to the first vertical portion of the adjacent first clamping member.

In another aspect, the present disclosure provides a cold beverage maker, including the above discharge device with a locking trigger structure for a cold beverage maker.

The technical solutions provided by the present disclosure may have the following beneficial effects:

1. After the discharge disc is mounted, the microswitch can detect whether the discharge disc is correctly and firmly locked on the housing in real time. When identifying the locked state of the discharge disc, the microswitch turns the circuit on to ensure normal discharge operation of the cold beverage maker. This prevents accidental leakage or damage due to a fact that the discharge disc is not locked, greatly improves the safety of the operation, and solves the problems of low efficiency and high error rate of the conventional method that determines the locked state of the discharge disc through experience of the worker.

2. The circular ring is movably stretched into the annular groove, such that an accurate guiding and locating mechanism can be provided for a clamping process of the discharge disc and the housing. This ensures that the discharge disc can be accurately aligned at the first discharge port when mounted.

### BRIEF DESCRIPTION OF THE DRAWINGS

FIG. 1 is a schematic view of a discharge device according to an embodiment of the present disclosure;

FIG. 2 is a schematic view of a discharge device according to an embodiment of the present disclosure;

FIG. 3 is a schematic view of a housing according to an embodiment of the present disclosure;

FIG. 4 is an exploded view of a discharge device according to an embodiment of the present disclosure;

FIG. 5 is an enlarged view of A shown in FIG. 4;

FIG. 6 is a schematic view of a housing according to an embodiment of the present disclosure;

FIG. 7 is an enlarged view of B shown in FIG. 7; and

FIG. 8 is a schematic view of an elastic piece according to an embodiment of the present disclosure.

In the figures: 1: housing, 11: first discharge port, 12: annular groove, 2: discharge disc, 21: second discharge port, 22: circular ring, 31: elastic piece, 32: first locating member, 321: guiding portion, 322: locating portion, 33: second locating member, 34: sensor, 35: tilt portion, 36: abutment portion, 37: locating hole, 41: first clamping member, 42: second clamping member, 43: first vertical portion, 44: first horizontal portion, 45: second vertical portion, 46: second horizontal portion, 47: second tilt sub-portion, 48: depression sub-portion, 49: first tilt sub-portion, and 50: protrusion sub-portion.

### DETAILED DESCRIPTION

The technical solutions of the present disclosure will be further described below with reference to the accompanying drawings and specific implementations.

In the description of the present disclosure, it should be understood that orientation or position relationships indicated by terms “length”, “middle”, “upper”, “lower”, “left”, “right”, “top”, “bottom”, and the like are orientation or position relationships as shown in the drawings, and these terms are just used to facilitate description of the present disclosure and simplify the description, but not to indicate or imply that the mentioned apparatus or element must have a specific orientation and must be constructed and operated in a specific orientation. Thus, these terms cannot be understood as a limitation to the present disclosure.

Moreover, the terms such as “first” and “second” are used only for the purpose of description and should not be construed as indicating or implying a relative importance, or implicitly indicating a quantity of indicated technical features. Thus, features defined with “first” and “second” may explicitly or implicitly include one or more of the features. In the description of the present disclosure, unless otherwise specified, “a plurality of”means at least two.

In the description of the present disclosure, it should be noted that, unless otherwise clearly specified and limited, meanings of terms “mount”, “splice”, and “connect” should be understood in a broad sense. For example, the “connect” may be a fixed connection, a removable connection or an integrated connection, may be a direct connection or an indirect connection implemented by using an intermediate medium, and may be intercommunication between two components. Those of ordinary skill in the art may understand specific meanings of the above terms in the present disclosure based on a specific situation.

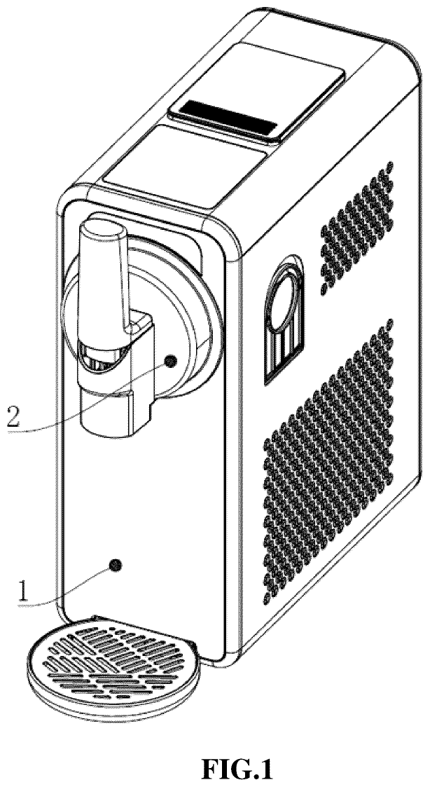

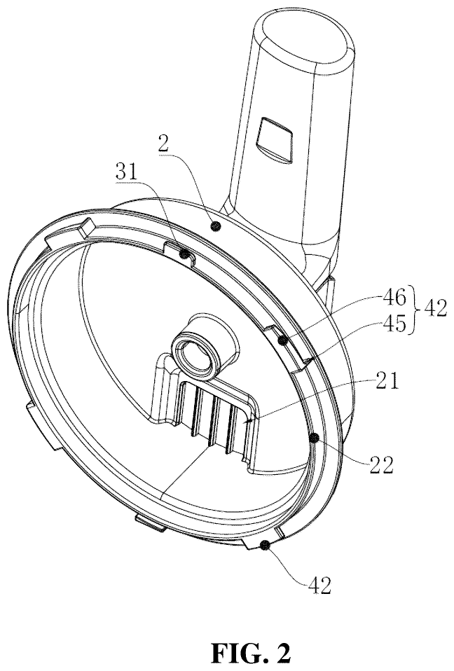

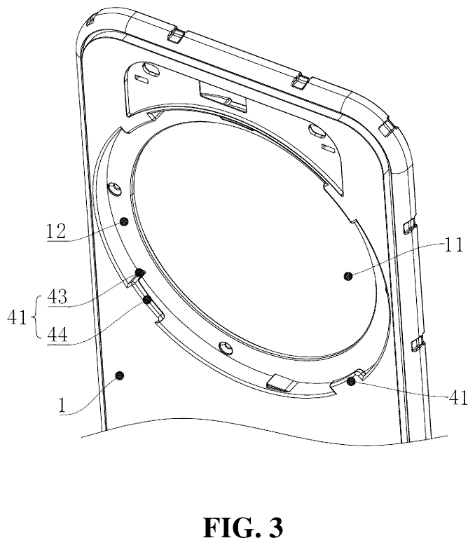

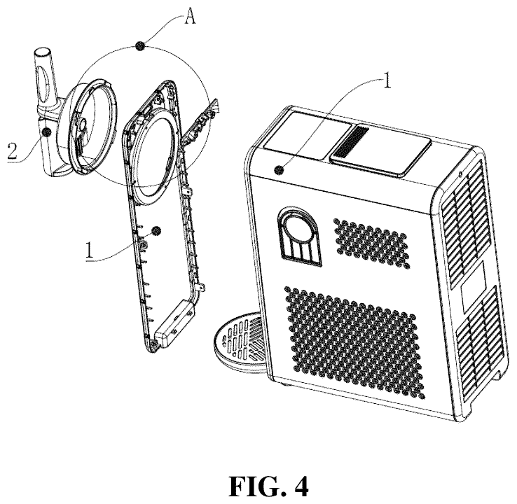

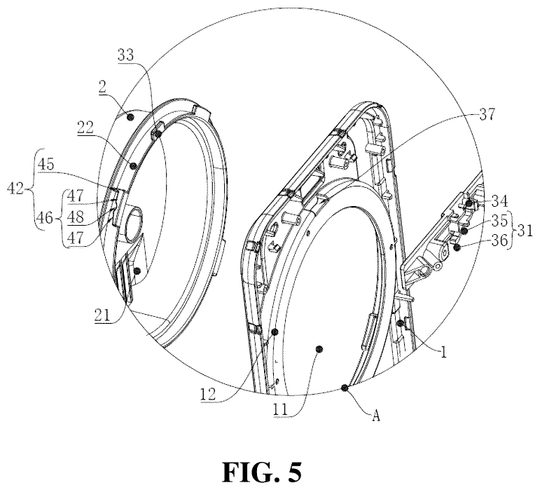

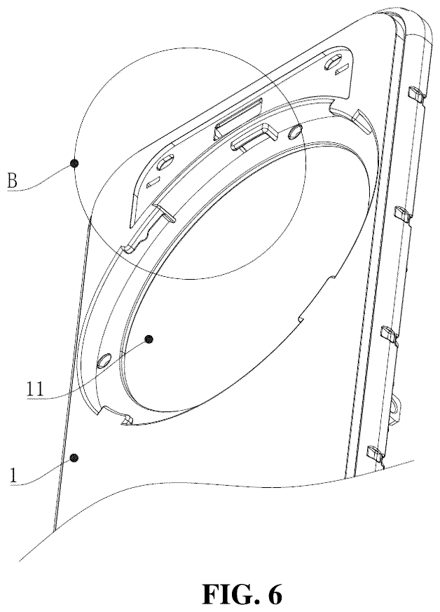

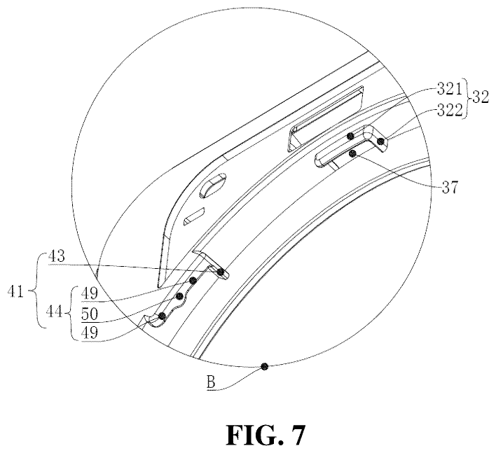

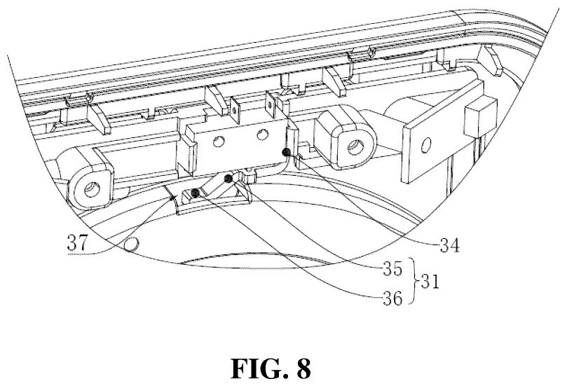

A discharge device with a locking trigger structure for a cold beverage maker in an embodiment of the present disclosure will be described below with reference to FIG. 1 to FIG. 8.

### Embodiment 1

A discharge device with a locking trigger structure for a cold beverage maker includes a housing 1 and a discharge disc 2. The housing 1 is provided with a first discharge port 11. The discharge disc 2 is provided with a second discharge port 21. The discharge disc 2 is mounted on the housing 1 through a clamping structure. The housing 1 is provided with a microswitch on a top of the first discharge port 11. The clamping structure is configured to detachably lock the discharge disc 2 and the housing 1. The discharge disc 2 is configured to seal the first discharge port 11. The microswitch is configured to identify whether the discharge disc 2 is locked and turn a circuit on or off.

The first discharge port 11 communicates with the second discharge port 21. The second discharge port 21 is configured to discharge ice cream or smoothie.

The discharge device with a locking trigger structure for a cold beverage maker in the embodiment is detachably mounted on the housing 1 through the clamping structure. The first discharge port 11 can be opened or sealed by the discharge disc 2. When the first discharge port 11 is sealed by the discharge disc 2, the ice cream or the smoothie cannot be affected by the external environment (such as temperature fluctuation and dust) in preparation or storage. With the clamping structure, the discharge disc 2 can be detached or mounted easily. This simplifies the cleaning and maintenance of the discharge device for the cold beverage maker.

After the discharge disc 2 is mounted, the microswitch can detect whether the discharge disc 2 is correctly and firmly locked on the housing 1 in real time. When identifying the locked state of the discharge disc 2, the microswitch turns the circuit on to ensure normal discharge operation of the cold beverage maker. This prevents accidental leakage or damage due to a fact that the discharge disc is not locked, greatly improves the safety of the operation, and solves the problems of low efficiency and high error rate of the conventional method that determines the locked state of the discharge disc 2 through experience of the worker.

The housing 1 is provided with an annular groove 12 at the first discharge port 11. The annular groove 12 is provided around the first discharge port 11. A side of the discharge disc 2 close to the housing 1 is provided with a circular ring 22. The circular ring 22 is movably stretched into the annular groove 12.

The clamping structure includes a first clamping member 41 and a second clamping member 42. A plurality of first clamping members 41 are provided around a sidewall of the annular groove 12. A plurality of second clamping members 42 are provided around a sidewall of the circular ring 22. The first clamping member 41 and the second clamping member 42 are in one-to-one correspondence, and are clamped with each other.

It is to be noted that the circular ring 22 is movably stretched into the annular groove 12, such that an accurate guiding and locating mechanism can be provided for a clamping process of the discharge disc 2 and the housing 1, and the discharge disc 2 can be accurately aligned at the first discharge port 11 when mounted. Meanwhile, the first clamping member 41 and the second clamping member 42 are in one-to-one correspondence, and are clamped with each other. This forms a strong locking force, effectively prevents the discharge disc 2 from becoming loose or falling off, and greatly enhances the stability and reliability in connection.

The microswitch includes an elastic piece 31, a first locating member 32, a second locating member 33, and a sensor 34. The first locating member 32 is mounted on a sidewall of the annular groove 12. The second locating member 33 is mounted on the circular ring 22. The first locating member 32 and the second locating member 33 are in one-to-one correspondence, and are clamped with each other. The annular groove 12 is provided with a locating hole 37 at the first locating member. The sensor 34 is mounted on a top of the locating hole 37 of the housing 1. The elastic piece 31 includes a mounting end provided on the sensor 34, and a movable end movably stretched into the locating hole 37. The second locating member 33 movably passes through the locating hole 37, and upwardly abuts against the elastic piece 31.

When the first clamping member 41 and the second clamping member 42 are clamped with each other, the first locating member 32 and the second locating member 33 are clamped with each other, and a top of the second locating member 33 abuts against the elastic piece 31. In response to an external force on the elastic piece 31, the sensor 34 senses microdeformation of the elastic piece 31 and turns the circuit on. By rotating the discharge disc 2 reversely, the first locating member 32 and the second locating member 33 are separated from each other. By this time, the elastic piece 31 does not suffer an acting force of the second locating member 33, and the sensor identifies a signal and turns the circuit off.

It is to be noted that the elastic piece 31 structure has desirable elasticity and restorability, and can remain stable performance after repeated use, thereby ensuring that the sensor 34 can turn the circuit off or on timely. Meanwhile, the elastic piece 31 also takes a buffer action to some extent to reduce damage to the device for the misoperation or external impact.

The elastic piece 31 includes a tilt portion 35 and an abutment portion 36. The tilt portion 35 is obliquely connected to the sensor 34 and the abutment portion 36. The abutment portion 36 movably penetrates into the locating hole 37.

In response to an external force on the abutment portion 36, the tilt portion 35 can cause certain elastic deformation, such that the sensor 34 can sense microdeformation of the abutment portion 36 more accurately to determine the locked state of the discharge disc 2. When the discharge disc 2 is correctly locked, the second locating member 33 pushes up the abutment portion 36, and the abutment portion 36 and the tilt portion 35 cause deformation. The sensor 34 can accurately capture the change of this state, to prevent the error possibly caused by the conventional subjective judgment.

Through mutual cooperation among the elastic piece 31, the second locating member 33 and the sensor 34, the present disclosure realizes automatic detection, without troublesome manual inspection of the worker or reliance on experience of the worker, thereby reducing the error rate caused by the human factor.

The first locating member 32 includes a guiding portion 321 and a locating portion 322. The guiding portion 321 and the locating portion 322 are provided around the locating hole 37. The locating portion 322 includes one end connected to an inner wall of the annular groove 12, and the other end perpendicularly connected to the guiding portion 321. A length direction of the locating portion 322 is the same as an axial direction of the first discharge port 11.

By rotating the discharge disc 2, the discharge disc 2 drives the second locating member 33 to rotate. Under guidance of the guiding portion 321, the second locating member 33 abuts against the locating portion 322, and the second locating member 33 is located in the locating hole 37, and upwardly abuts against the abutment portion 36. Moreover, the guiding portion 321 takes a desirable guiding effect. This reduces the impact and abrasion caused by direct hard connection, and effectively prolongs the service life of the first locating member 32.

The first clamping member 41 includes a first vertical portion 43 and a first horizontal portion 44 that are perpendicular to each other. An end of the first vertical portion 43 away from the first horizontal portion 44 is connected to an inner wall of the annular groove 12. The first horizontal portion 44 is flush with an outer surface of the housing.

The second clamping member 42 includes a second vertical portion 45 and a second horizontal portion 46 that are perpendicular to each other. An end of the second vertical portion 45 away from the second horizontal portion 46 is connected to an inner wall of the discharge disc 2. The second horizontal portion 46 is flush with an end of the circular ring 22.

Both a length direction of the first vertical portion 43 and a length direction of the second vertical portion 45 are the same as an axial direction of the first discharge port 11.

Both the first clamping member 41 and the second clamping member 42 are an L-shaped structure, which can increase the strength and hardness of the circular ring 22 and the annular groove 12. The first vertical portion 43 is firmly connected to the inner wall of the annular groove 12, and the second vertical portion 45 is firmly mounted on the inner wall of the discharge disc 2. This ensures that the first clamping member 41 and the second clamping member 42 under a force do not become loose or fall off easily. The first horizontal portion 44 is flush with the outer surface of the housing, and the second horizontal portion 46 is flush with the end of the circular ring 22. This can further enhance the strength and stability of the connection, such that the housing 1 and the discharge disc 2 are connected more stably and reliably to bear a greater external force and a greater impact.

With the L-shaped structure, when the first clamping member 41 and the second clamping member 42 are combined, the first vertical portion 43 and the second vertical portion 45 are located relatively to realize preliminary fixation, and the first horizontal portion 44 and the second horizontal portion 46 abut against each other to form a more stable supporting surface. The dual function significantly improves the overall stability and bearing capacity of the connection, and reduces the risk of looseness or deformation due to the external force.

Besides, by rotating the discharge disc 2 reversely, the first clamping member 41 and the second clamping member 42 are separated from each other. The discharge disc 2 can be detached quickly by the worker for maintenance or replacement, thereby shortening the maintenance time, and improving the overall availability and operation efficiency of the device.

The second horizontal portion 46 of the second clamping member 42 is close to the second vertical portion 45 of the adjacent second clamping member 42.

The first horizontal portion 44 of the first clamping member 41 is close to the first vertical portion 43 of the adjacent first clamping member 41.

The first clamping members 41 and the second clamping members 42 are arranged clockwise. With the clockwise arrangement, the assembly process of the discharge disc 2 is simplified greatly. Rotating the discharge disc 2 counterclockwise can separate the first clamping member 41 and the second clamping member 42, thereby quickly detaching the discharge disc 2. By rotating the discharge disc 2 clockwise, the first clamping portion can be clamped with the second clamping portion naturally and smoothly, without being adjusted or aligned additionally. This significantly improves the working efficiency, and reduces the operation time.

### Embodiment 2

The embodiment differs from Embodiment 1 in: A side of the second horizontal portion 46 close to the first horizontal portion 44 is provided with a second tilt sub-portion 47 and a depression sub-portion 48. Two ends of the depression sub-portion 48 are respectively connected to two second tilt sub-portions 47.

A side of the first horizontal portion 44 close to the second horizontal portion 46 is provided with a first tilt sub-portion 49 and a protrusion sub-portion 50. Two ends of the protrusion sub-portion 50 are respectively connected to two first tilt sub-portions 49.

The depression sub-portion 48 is clamped with the protrusion sub-portion 50. The first tilt sub-portion 49 abuts against the second tilt sub-portion 47.

It is to be noted that the depression sub-portion 48 is clamped with the protrusion sub-portion 50 accurately, such that the first clamping member 41 and the second clamping member 42 are locked more closely, thereby effectively preventing relative displacement caused by vibration or an external force, and enhancing stability and reliability of the overall structure.

The first tilt sub-portion 49 abuts against the second tilt sub-portion 47. This not only increase the contact area, but also guides and disperses a stress in the clamping process through a tilt angle to effectively reduce local stress concentration and prolong the service life of the clamping structure.

When the protrusion sub-portion 50 is completely embedded into the depression sub-portion 48, a wedge-shaped locking effect is formed because of the tilt sub-portion. With the self-locking mechanism, the clamping structure can generate a greater resistance when tensed reversely to further enhance the stability of the connection.

In another aspect, the present disclosure further provides a cold beverage maker, including the above discharge device with a locking trigger structure for a cold beverage maker.

The technical principles of the present disclosure are described above with reference to the specific embodiments. These descriptions are merely intended to explain the principles of the present disclosure, and cannot be construed as limiting the protection scope of the present disclosure in any way. Based on the explanation herein, those skilled in the art may associate other specific implementations of the present disclosure without creative effort, and these implementations should fall within the protection scope of the present disclosure.

1. A discharge device with a locking trigger structure for a cold beverage maker, comprising a housing and a discharge disc, wherein the housing is provided with a first discharge port; the discharge disc is provided with a second discharge port; the discharge disc is mounted on the housing through a clamping structure; the housing is provided with a microswitch on a top of the first discharge port; the clamping structure is configured to detachably lock the discharge disc and the housing; the discharge disc is configured to seal the first discharge port; and the microswitch is configured to identify whether the discharge disc is locked and turn a circuit on or off; and
the first discharge port communicates with the second discharge port; and the second discharge port is configured to discharge ice cream or smoothie.

2. The discharge device with a locking trigger structure for a cold beverage maker according to claim 1, wherein the housing is provided with an annular groove at the first discharge port; the annular groove is provided around the first discharge port; a side of the discharge disc close to the housing is provided with a circular ring; and the circular ring is movably stretched into the annular groove; and
the clamping structure comprises a first clamping member and a second clamping member; a plurality of first clamping members are provided around a sidewall of the annular groove; a plurality of second clamping members are provided around a sidewall of the circular ring; and the first clamping member and the second clamping member are in one-to-one correspondence, and are clamped with each other.

3. The discharge device with a locking trigger structure for a cold beverage maker according to claim 1, wherein the microswitch comprises an elastic piece, a first locating member, a second locating member, and a sensor; the first locating member is mounted on a sidewall of the annular groove; the second locating member is mounted on the circular ring; the first locating member and the second locating member are in one-to-one correspondence, and are clamped with each other; the annular groove is provided with a locating hole at the first locating member; the sensor is mounted on a top of the locating hole of the housing; the elastic piece comprises a mounting end provided on the sensor, and a movable end movably stretched into the locating hole; and the second locating member movably passes through the locating hole, and upwardly abuts against the elastic piece.

4. The discharge device with a locking trigger structure for a cold beverage maker according to claim 3, wherein the elastic piece comprises a tilt portion and an abutment portion; the tilt portion is obliquely connected to the sensor and the abutment portion; and the abutment portion movably penetrates into the locating hole.

5. The discharge device with a locking trigger structure for a cold beverage maker according to claim 4, wherein the first locating member comprises a guiding portion and a locating portion; the guiding portion and the locating portion are provided around the locating hole; the locating portion comprises one end connected to an inner wall of the annular groove, and the other end perpendicularly connected to the guiding portion; and a length direction of the locating portion is the same as an axial direction of the first discharge port.

6. The discharge device with a locking trigger structure for a cold beverage maker according to claim 2, wherein the first clamping member comprises a first vertical portion and a first horizontal portion that are perpendicular to each other; an end of the first vertical portion away from the first horizontal portion is connected to an inner wall of the annular groove; and the first horizontal portion is flush with an outer surface of the housing;
the second clamping member comprises a second vertical portion and a second horizontal portion that are perpendicular to each other; an end of the second vertical portion away from the second horizontal portion is connected to an inner wall of the discharge disc; and the second horizontal portion is flush with an end of the circular ring; and
both a length direction of the first vertical portion and a length direction of the second vertical portion are the same as an axial direction of the first discharge port.

7. The discharge device with a locking trigger structure for a cold beverage maker according to claim 6, wherein a side of the second horizontal portion close to the first horizontal portion is provided with a second tilt sub-portion and a depression sub-portion; and two ends of the depression sub-portion are respectively connected to two second tilt sub-portions;
a side of the first horizontal portion close to the second horizontal portion is provided with a first tilt sub-portion and a protrusion sub-portion; and two ends of the protrusion sub-portion are respectively connected to two first tilt sub-portions; and
the depression sub-portion is clamped with the protrusion sub-portion; and the first tilt sub-portion abuts against the second tilt sub-portion.

8. The discharge device with a locking trigger structure for a cold beverage maker according to claim 6, wherein the second horizontal portion of the second clamping member is close to the second vertical portion of the adjacent second clamping member; and
the first horizontal portion of the first clamping member is close to the first vertical portion of the adjacent first clamping member.

9. A cold beverage maker, comprising the discharge device with a locking trigger structure for a cold beverage maker according to claim 1.
